(19) United States
(12) Patent Application Publication
(10) Pub. No.: US 2026/0111206 A1
(43) Pub. Date: Apr. 23, 2026

(54) BUILDING FILE BUNDLES USING CLIENT DEVICE-HOSTED WORKER AGENTS

(71) Applicant: Hewlett Packard Enterprise Development LP, Spring, TX (US)

(72) Inventors: Giridhara Rangenahalli Pandurangaiah, Bangalore (IN); Govardhan Hariprasad Gejjala, Bangalore (IN); Jhanvi Dattani, Bangalore (IN)

(21) Appl. No.: 18/980,312

(22) Filed: Dec. 13, 2024

(30) Foreign Application Priority Data
Oct. 21, 2024 (IN) 202441079875

(51) Int. Cl. G06F 8/61; G06F 9/451

(52) U.S. Cl. CPC G06F 8/61; G06F 9/451

(57) ABSTRACT

A technique includes a server providing a user interface that is accessible by a client device. The technique includes the server causing launching of a client worker agent on the client device; and the server, responsive to the launching of the client worker agent, communicates with the client device to cause the client worker agent to export functions of the client worker agent to the server. The technique includes receiving, by the server, an input, via the user interface and from the client device, associating a file bundle with a plurality of files. The technique includes responsive the server, responsive to receiving, via the user interface and from the client device, a build request to build a file bundle, invoking the functions to cause the client device to build the file bundle.

### BACKGROUND

A computer platform original equipment manufacturer (OEM) may release a "service pack" that covers a collection of computer platform models that are manufactured by the OEM. A service pack contains software and firmware files that are associated with patches, updates and enhancements for the computer platform models.

### BRIEF DESCRIPTION OF THE DRAWINGS

FIG. 1 is a block diagram of a computer network having a client device-hosted file-bundling worker agent to build a file bundle corresponding to a custom service pack, according to an example implementation.

FIGS. 2A and 2B depict block diagrams of a file-bundling architecture in different states according to an example implementation.

FIG. 3 is a sequence flow diagram depicting actions taken by a client device and a server to select features of a file bundle and deploy a file-bundling worker agent on the client device to build the file bundle, according to an example implementation.

FIG. 4 is a sequence flow diagram depicting actions taken by a client device and a server to build a file bundle using a file-bundling worker agent of the client device, according to an example implementation.

FIG. 5 is an illustration of hardware processor-readable instructions that are stored on a non-transitory storage medium and when executed by a hardware processor, cause a server to cause a client worker agent to be launched on a client device for purposes of using the client device to build a file bundle, according to an example implementation.

FIG. 6 is a flow diagram depicting a technique to cause, by a server, launching of a client worker agent on a client device for purposes of using the client device to build a file bundle, according to an example implementation.

FIG. 7 is a block diagram of a computer platform that includes a hardware processor to, responsive to accessing a portal provided by a server, receive and execute a client module to build a file bundle, according to an example implementation.

### DETAILED DESCRIPTION

A computer platform OEM may provide a base release of software and firmware that covers a number of the OEM's computer platform models (e.g., server models). The OEM may subsequently release service packs (corresponding to different service pack versions) that reference the base release and contain patches, updates and enhancements for the computer platform models. For example, a service pack may contain firmware updates for certain peripherals, system firmware updates, new utilities and operating system patches. A service pack includes a collection of constituent files, which, for purposes of delivery, are bundled together in a single file (e.g., a bootable ISO image file).

A service pack may cover multiple computer platform models, multiple operating systems and peripherals, and due to this wide scope of coverage, the service pack may be considerably large (e.g., a service pack may correspond to a file that is several gigabytes (GBs) in size). A given customer may not use a number of the service pack's constituent files. For example, a given customer may own computer platforms that correspond to three of ten computer platform models and two of five operating systems covered by a service pack, which means that, for this customer, the service pack contains a number of unused files. Moreover, a service pack may contain firmware packages, peripheral firmware, software and other features that are not used by the customer, which correspond to additional files that are not used by the customer. An OEM may provide a custom service pack creation service that may be used by a customer to create, from the original, released service pack, a reduced-size, custom service pack that is tailored to the customer's computer platforms.

In an example, a custom service pack creation service may allow a customer to select, through filter options, specific features (e.g., computer platform models, operating systems and firmware packages) that correspond to a smaller subset of a released service pack's software and firmware. When the customer is satisfied with the selections, the customer may then request the custom service pack creation service to a build a custom service pack. The custom service pack may correspond to a bootable ISO image file that has a significantly reduced size (e.g., a file size less than 1 GB) relative to the original service pack release.

In one approach, as part of a custom service pack creation service, an OEM provides resources for building custom service packs. For example, an OEM may provide a web site, or portal, which serves as a mechanism for a customer to select features of a custom service pack and initiate a build of the custom service pack. For example, by accessing the portal, a customer may specify filter options and initiate the building of the custom service pack. The custom service packs are built by back-end workers hosted by OEM-provided resources. In an example, the back-end workers may be application processes that are deployed in containers of the OEM-provided resources. To build a service pack, a back-end worker retrieves the selected constituent files from one or multiple file stores, and then the back-end worker packages the selected constituent files into a single file corresponding to the custom service pack.

Because the building of custom service packs consumes significant resources, an OEM may limit the number of its back-end workers and correspondingly, limit the number of concurrent custom service pack builds across all customers. Such a constraint may lead to the queuing of custom service pack build requests and result in long wait times (e.g., hours to days) for queued build requests to be served. Moreover, after custom service packs are built, the custom service packs are stored in the OEM's storage resources until the custom service packs are retrieved by the customers. Customers may experience slow download speeds when retrieving custom service packs due to bandwidth limitations associated with the storage resources. Additionally, for purposes of managing the storage space occupied by stored and yet-to-be retrieved custom service packs, the OEM may impose a time to live (TTL) rule, or policy, on custom service packs. For example, a TTL policy may specify that a custom service pack is retained in storage for customer retrieval for up to one week after the build date, and expiration of the one-week time limit, the custom service pack is deleted. For any of a variety of reasons (e.g., a missed build completion notification, an unawareness of the TTL policy or an overlooked TTL deadline), a customer may not return to retrieve a custom service pack before the custom service pack is deleted. Consequently, the customer may be forced to restart the custom service pack creation process from the beginning.

In accordance with example implementations that are described herein, a file-bundling architecture includes a server, a file-bundling worker agent and a client device. The server regulates access to a collection of files that are available for inclusion in custom file bundles (e.g., files bundles corresponding to respective custom service packs). In an example, the server is affiliated with an OEM and a custom service pack creation service, the client device is associated with a customer, and the custom file bundle corresponds to a custom service pack whose content is derived from a particular service pack release. Through the client device, an end user may submit a request, to the server, to build a file bundle containing constituent files (from the collection of available files) that are selected by the user. Instead of the server or back-end resources building the requested file bundle, the server deploys a file-bundling worker agent to the client device. The file-bundling worker agent performs the operations (e.g., file retrieval operations and operations to construct the single file corresponding to the file bundle) to build the file bundle. As can be appreciated, the file-bundling worker agent is hosted by the client agent and therefore, consumes resources of the client device to build the file bundle.

In the context that is used herein, a "file bundle" refers to a collection of files (called the "constituent files" herein) that are packaged as a single file. The building of a file bundle includes retrieving constituent files for the file bundle and assembling the constituent files in a data container that corresponds to a particular file format (e.g., a file format specified by a customer). In an example, a file bundle corresponds to a custom service pack, which is derived from a collection of files associated with a particular service pack release. In an example, a file bundle corresponds to an ISO image file. An "ISO image file" represents data as exactly stored on a physical drive. In an example, an ISO image file corresponds to an International Organization for Standardization (ISO) 9660 optical disk image. In another example, a file bundle corresponds to a tape archive (TAR) file. In another example, a file bundle corresponds to a ZIP file. A file bundle is also referred to herein as a "completed" or "built" file bundle to distinguish an intermediate product of a file-bundling process from the file bundle in its final form.

In an example, the server may be affiliated with a computer platform OEM that provides a service pack, a file bundle, which contains a collection of files. The server hosts a front-end application that provides, or serves, a web site, or portal, which may be accessed by customers of the OEM to create custom file bundles corresponding to custom service packs. More specifically, a user affiliated with a customer, may, via a client device, log into the portal for purposes of creating a custom file bundle. In this manner, through the portal, the user selects features of the file bundle. In an example, the user selects file options that correspond to constituent files to be included in the file bundle. In another example, the user selects a file type (e.g., an ISO image file, a TAR file or a ZIP file) of the file bundle. The user may also, through the portal, submit a file bundle build request to initiate operations to build the file bundle. Instead of server-side resources being used to build the file bundle, the front-end application deploys a file-bundling worker agent to the user's client device, which starts, or launches, on the client device. Moreover, in accordance with example implementations, the front-end application invokes build functions of the file-bundling worker agent, which correspond to client device operations to build the file bundle. Additionally, in accordance with example implementations, the file-bundling worker agent invokes status functions of the front-end application to cause the front-end application to update build status information on the portal. In examples, the portal may display a build progress status, a build completion notification or other status-related information about the file bundle or progress of building the file bundle.

Among the potential advantages of the file-bundling architecture that is described herein, after the client device finishes building the file bundle, the file bundle is immediately available to the customer. The building of a file bundle may begin soon after a file bundle build request is submitted without any build wait time being imposed due to resource constraints. The file bundle is not subject to a TTL policy.

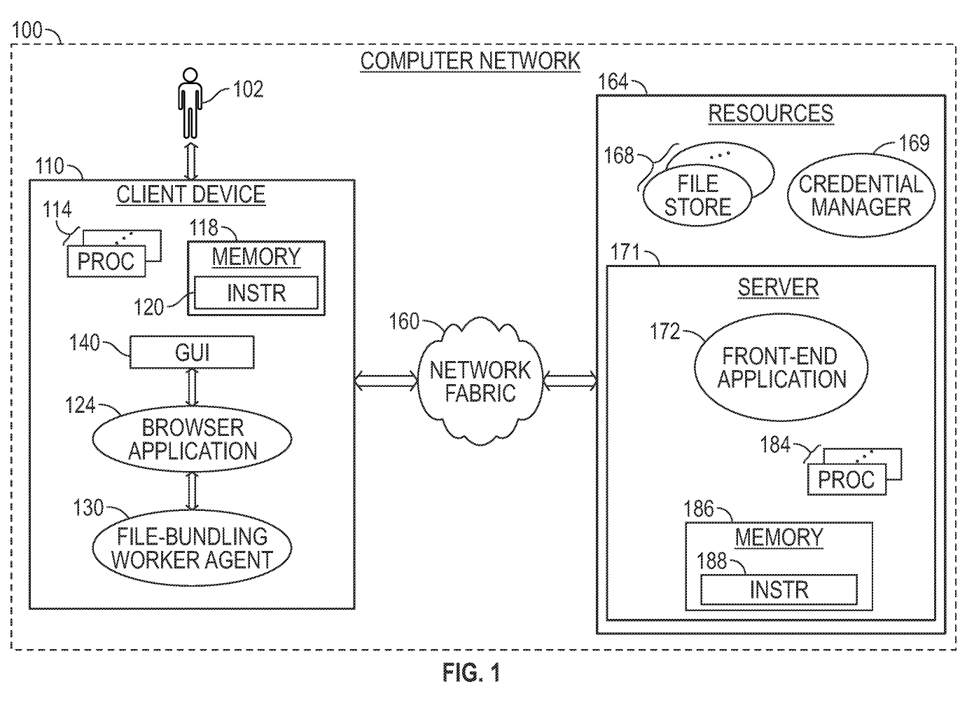

Referring to FIG. 1, a computer network 100 in accordance with example implementations, includes a server 171 that hosts a front-end application 172. The front-end application 172 serves a web site, or portal, which corresponds to a service to build file bundles. In an example, the server 171 is affiliated with an OEM, and the portal allows a customer of the OEM to select features (e.g., the constituent files and the bundle file type) for a custom file bundle, and when the customer is satisfied with the selected features, the customer may initiate, via the portal, operations to build the file bundle. In an example, a custom file bundle is a custom service pack that includes customer-selected files from a larger set of files contained in a particular service pack release by the OEM.

The portal may be accessed by the customers via client devices, such as an exemplary client device 110 that is depicted in FIG. 1. In examples, the client device 110 may be a laptop computer, a tablet computer, a smartphone, a desktop computer, or another processor-based electronic device. In an example, the client device 110 is an edge device and is part of a local branch network (e.g., a local area network (LAN)) that provides device connectivity to the computer network 100. As depicted in FIG. 1, the client device 110 and the server 171 communicate over a network fabric 160. In accordance with example implementations, the network fabric 160 may be associated with one or multiple types of communication networks, such as (as examples) Fibre Channel networks, Compute Express Link (CXL) fabric, dedicated management networks, LANs, wide area networks (WANs), global networks (e.g., the Internet), wireless networks, or any combination thereof.

The portal corresponds to a graphical user interface (GUI) 140 that is viewed on a display screen of the client device 110. In accordance with example implementations, the GUI 140 corresponds to display window content generated by a navigation application, or browser application 124 (e.g., an Internet browser application). An end user 102 who is affiliated with a customer may access the portal by entering, in a displayed address bar of the browser application 124, text corresponding to a Uniform Resource Locator (URL) of the portal. In an example, the front-end application 172 prompts the user 102 for credentials, and after logging into the portal by providing the credentials, the front-end application 172 provides, to the browser application 124, content corresponding to the GUI 140. The user 102, by interacting with the GUI 140, may select features of a to-be-built file bundle. When the end user 102 is satisfied with the selected features, the end user 102 may, via the GUI 140, submit a build request to the front-end application 172. Instead of server-side, or back-end, file building operations being used to build the requested file bundle, the front-end application 172 deploys a file-bundling worker agent 130 to the client device 110.

FIG. 1 depicts the file-bundling worker agent 130 after the worker agent 130 has been deployed to the client device 110. The file-bundling worker agent 130 performs file-bundling build operations to produce a completed file bundle. Therefore, as the file-bundling worker agent 130 is hosted on the client device 110, resources of the client device 110 are used to build the file bundle. In accordance with some implementations, a single instance of the file-bundling worker agent 130 may be used to build multiple file bundles.

In the context that is used herein, "file-bundling build operations" (or "build operations") refer to a collection of operations to retrieve constituent files for a file bundle and assemble the constituent files into a single file package that corresponds to the file bundle. An example file-bundling build operation is the file-bundling worker agent 130 retrieving a constituent file for a file bundle from a file store 168. Another example file-bundling build operation is the file-bundling worker agent 130, after retrieving all of the constituent files for a file bundle, assembling the files into a single file that has a file type which is referred to as the "bundle file type" herein. In examples, the bundle file may be an ISO image file, a TAR file or a ZIP file.

In accordance with example implementations, the front-end application 172 deploys the file-bundling worker agent 130 by sending, to the browser application 124, program code corresponding to a file-bundling worker agent module. In an example, the file-bundling worker agent module is a WebAssembly module. In an example, the user 102 selects a "build button" of the GUI 140, which causes the browser application 124 to send a request, called an application programming interface (API) call, to an API of the front-end application 172. In the context used herein, an "API" refers to a collection of software components, which collectively provide one or multiple functions, operations or actions. In response to the API call, the front-end application 172 sends to the browser application 124, as part of an API response, a file corresponding to the file-bundling worker agent module. In accordance with example implementations, the browser application 124 executes the file-bundling worker agent module to launch, or start, the file-bundling worker agent 130.

In accordance with example implementations, after launching, the file-bundling worker agent 130 exports file-bundling build functions (or "build functions") to the front-end application 172. In the context that is used herein, the "exporting" of a function to an entity (e.g., the front-end application 172) refers to the function being exposed to the entity so that the entity may invoke the function. In an example, an exported build function corresponds to an API of the file-bundling worker agent 130, and the front-end application 172 invokes the build function by providing an API call to this API. In an example, the front-end application 172 invokes a build function of the file-bundling worker agent 130 to cause the worker agent 130 to retrieve a selected constituent file for a file bundle. In another example, after all of the constituent files are retrieved by the file-bundling worker agent 130, the front-end application 172 invokes a build function of the file-bundling worker agent 130 to cause the agent 130 to package, or assemble, the constituent file into a file that corresponds to the selected file bundle file type.

The front-end application 172, in accordance with example implementations, includes build status functions (also referred to as "status functions" herein) that the application 172 exports to the file-bundling worker agent 130. A build status function, in accordance with example implementations, causes the front-end application to display, on the GUI 140, information about a file bundle build. The exporting of the front-end application's build status functions to the file-bundling worker agent 130 allows the worker agent 130 to invoke (e.g., invoke via API calls) the build status functions to update the user 102 about the progress of a file bundle build. In an example, a build status function displays, on the GUI 140, a percentage of progress (e.g., a percentage of the overall estimated build time, which has been completed) of the build. In another example, a build status function displays, on the GUI 140, a time remaining until the build is complete and the file bundle is available. In another example, a build status function displays, on the GUI 140, a number of the bundle's constituent files that have been retrieved. In another example, a build status function displays, on the GUI 140, a number of constituent files to be retrieved. In other example, a build status function displays, on the GUI 140, a current phase of the build (e.g., indicates that files are being retrieved, or indicates that an ISO image file, TAR file or ZIP is being built). In another example, a build status function displays, on the GUI 140, a notification that the file bundle is available. In another example, a build status function displays, on the GUI 140, a notification that a particular error has occurred in connection with the file bundle build.

The user 102 may provide input to the front-end application 172 by interacting with the GUI 140. The interaction with the GUI 140 may involve user actions that manipulate input mechanisms that result in data, commands, instructions, selections, credentials or other input being sent to the front-end application 172. In examples, the user actions may include mouse movements, mouse button clicks, touchscreen gestures, touchpad gestures, touchpad clicks, keyboard entry, scanning, or any other actions that indicate user input. An input mechanism refers to a virtual or physical tool for receiving data, instructions, selections or commands from a user. In examples, an input mechanism may correspond to a graphically-displayed element or group of elements of the GUI 140, such as a depressible button, a sliding button, a text entry box, a radio button, a hyperlink or other virtual control. In other examples, an input mechanism may be a key, a keypad, a keyboard, a mouse, a touch pad, a touch screen, a voice recognition sensor, a stylus sensor or other physical device.

The GUI 140 also provides, to the user 102, output from the front-end application 172. In examples, an output corresponds to a displayed login prompt. In another example, an output corresponds to a displayed file selection option (called "filter options" herein). In examples, a filter option may correspond to selection of one or multiple of an operating system, an operating system version, a firmware package, a firmware package version, a computer platform model or a computer platform model version. In another example, an output corresponds to a displayed list of available bundle file types. In another example, an output corresponds to a displayed selected bundle file type. In another example, an output corresponds to a display of selected constituent files for a file bundle. In another example, an output corresponds to a displayed status of a file bundle build.

Among the other features of the computer network 100, the client device 110 includes one or multiple hardware processors 114. A hardware processor 114 may include one or multiple processing cores, such as one or multiple central processing unit (CPU) cores and/or one or multiple graphics processing unit (GPU) cores. The client device 110 also includes a system memory 118. The system memory 118, as well as other memories described herein, includes non-transitory storage media that may be formed from semiconductor storage devices, memristor-based storage devices, magnetic storage devices, phase change memory devices, a combination of devices or one or more of these storage technologies, and so forth. The system memory 118 may represent a collection of memories of both volatile memory devices and non-volatile memory devices.

The system memory 118 stores hardware processor-readable instructions 120 that, when executed by one or multiple hardware processors 114 cause the hardware processor(s) to form one or multiple software components of the client device 110. An instance of the browser application 124 is an example of a software component. An instance of the file-bundling worker agent 130 is an example of a software component.

The server 171 is hosted on resources 164. In an example, the resources 164 are shared resources, such as resources that correspond to a public cloud. In accordance with further implementations, the resources 164 may be associated with a private cloud. For example, the resources 164 may be on-premise resources (e.g., on-premise resources affiliated with an OEM) that are located in a private datacenter or a co-location datacenter. In accordance with further implementations, the resources 164 may be associated with a hybrid cloud. In accordance with further implementations, the resources 164 may be private on-premise resources that are not cloud-based. In the context that is used herein, cloud-based resources refer to resources that may be scaled up or down on demand (e.g., scaled up or down to correspond to a workload demand).

The server 171 may be virtual or physical, depending on the particular implementation. In an example, the server 171 is a virtual machine. In another example, the server 171 is a physical machine, such as enclosure-based server (e.g., a blade server), a rack server (e.g., a density line (DL) server), or a tower server.

In another example, the server 171 is a distributed server. In this context, a "distributed server" refers to a collection of independent compute nodes that coordinate their work to perform tasks. In an example, the front-end application 172 is a microservice-based application, and the microservices of the application 172 correspond to worker nodes of an orchestrated container cluster. A worker node may be virtual or physical. In an example, the server 171 may have multiple physical compute nodes, with a given physical compute node hosting one or multiple worker nodes. In an example, a worker node hosts a collection of container pods, and each container pod corresponds to an instance of a microservice of the front-end application 172. In another example, the front-end application 172 is a monolithic application.

In another example, the server 171 is a software-defined server (SDS). An SDS is a virtual machine that is hosted on multiple physical compute nodes.

Regardless of its particular form or architecture, the server 171 includes one or multiple processors 184 and a memory 186. Depending on the particular implementation, the processors 184 may be physical hardware processors; or the processors 184 may be virtual and correspond to underlying physical hardware processors. In a similar manner, depending on the particular implementation, the memory 186 may be a collection of physical memory devices; or the memory 186 may be a collection of virtual memory devices that correspond to underlying physical memory devices. In an example, a processor 184 may include one or multiple CPU cores and/or one or multiple GPU cores. In an example, one or multiple processors 184 may execute processor-readable instructions, such as instructions 188 that are stored in the memory 186, for purposes of providing one or multiple instances of the front-end application 172.

The resources 164 also include one or multiple file stores 168. In an example, a file store 168 stores one or multiple files associated with a service pack release. In an example, a particular file store 168 may store all of the files of a particular service pack release. In another example, there may be multiple file stores 168 that each store all of the files of a particular service pack release. In another example, the files of a particular service pack release are distributed across multiple file stores 168. In an example, a file stored in a file store 168 may be associated with a particular URL so that the file is identified by the URL.

In accordance with example implementations, a file store 168 allows retrieval of a file stored in the file store 168 if the requestor (e.g., a file-bundling worker agent 130) provides a corresponding file access credential. In another example, a particular file store 168 may be associated with a particular file access credential, so that a requestor may retrieve any of the files stored by the file store 168 by presenting the file access credential. The file access credential may take on any of a number of different forms. In an example, a file access credential may be a time-limited cryptographic key. In another example, a file access credential may be an authorization bearer token, such as a JavaScript Object Notation (JSON) web token, or "JWT", that includes an identifier for the requestor in the payload of the JWT. In an example, the time that a file access credential is valid may correspond to a duration of a JWT. The file access credential, in accordance with some implementations, may have a relatively short life (e.g., a life of less than a minute or another time limit) before the credential is invalid. In accordance with further implementations, a file access credential may not be time-limited.

In accordance with some implementations, the resources 164 include a credential manager 169, which provides file access credentials and URLs to the front-end application 172. In an example, the front-end application 172 submits a request, to the credential manager 169, for a URL and a file access credential for a particular file. In an example, the request includes identifying information (e.g., a file name) for the file. In an example, the credential manager 169, in a response to the request, retrieves a URL for the file, generates a time-limited file access credential, and sends, to the front-end application 172, the URL and the time-limited file access credential. The front-end application 172 may then provide the URL and the time-limited file access credential to the file-bundling worker agent 130 (e.g., provide the URL and time-limited file access credential in association with an API call by the application 172 to invoke a worker agent build function to retrieve the file).

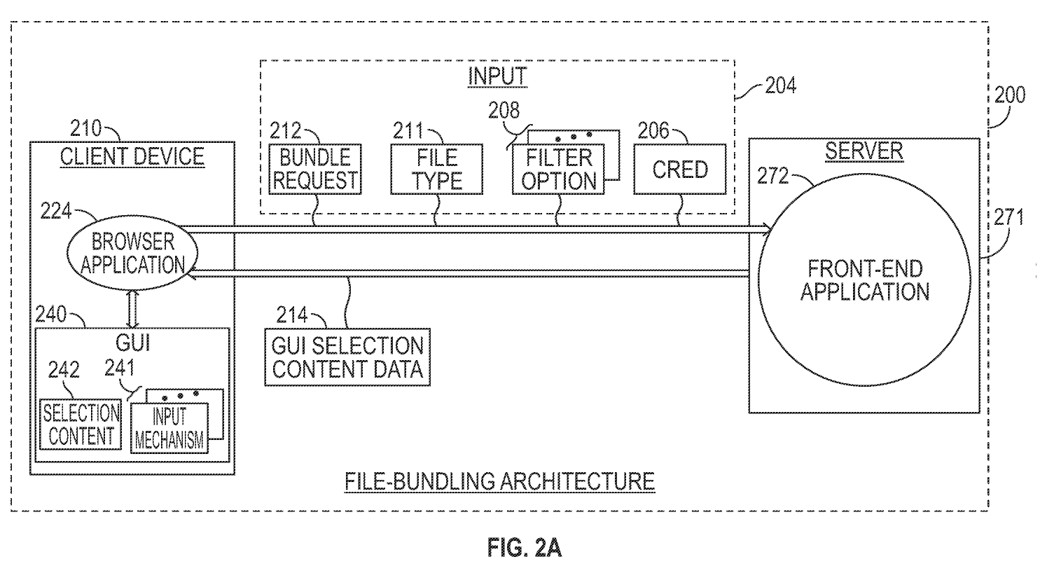

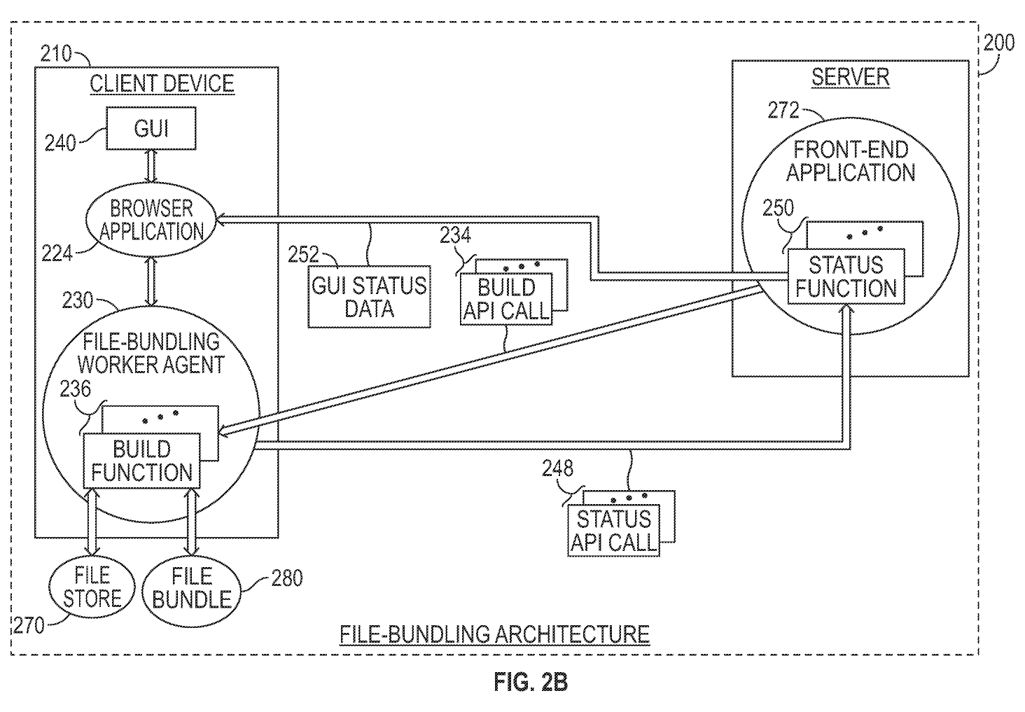

FIGS. 2A and 2B depict a file-bundling architecture 200 in two different states. FIG. 2A depicts the file-bundling architecture 200 in a state before deployment of a file-bundling worker agent, and FIG. 2B depicts the file-bundling architecture 200 in a state after deployment of the file-bundling worker agent.

Referring to FIG. 2A, the file-bundling architecture 200 includes a client device 210 and a server 271. The client device 110 and the server 171 of FIG. 1 are examples of the client device 210 and the server 271, respectively. The client device 210 hosts a browser application 224 that provides a GUI 240. The browser application 124 and the GUI 140 of FIG. 1 are examples of the browser application 224 and the GUI 240, respectively. The server 271 hosts a front-end application 272. The front-end application 172 of FIG. 1 is an example of the front-end application 272.

In accordance with example implementations, the browser application 224 and the front-end application 272 communicate with each other using web APIs and web API responses. Web APIs allow applications to interact with each other at the application layer of the Open Systems Interconnection (OSI) model. In an example, the browser application 224 and the front-end application 272 may communicate web APIs and web API responses using a secure Hypertext Transfer Protocol, or "HTTPS." In an example, the web APIs and web API responses may correspond to a Representation State Transfer, or "REST," API model. In another example, the web APIs and web API response may correspond to a Remote Procedure Call, or "RPC," API model. A web API call is sent by a requesting application to a recipient application for purposes of requesting, sending, deleting, adding or modifying a resource. In examples, a resource may be a hypertext document, document layout instructions, data, text content, an input, a file, a video, a script, an image, program code, a program code module, an object, an acknowledgment or other information.

In an example, in response to input indicating selection of a hyperlink by a user, the browser application 224 sends a corresponding web API call to the front-end application 272, and the front-end application 272 responds with a hypertext document corresponding to the selected hyperlink. In an example, in response to input by a user representing selection of a filter option 208, the browser application 224 sends a corresponding web API call to the front-end application 272, and the front-end application 272 responds with a web API response containing a hypertext document that contains files corresponding to the selected filter option. In another example, in response to input indicating selection of a build button by a user, the browser application 224 sends a corresponding web API call to the front-end application 272, and the front-end application 272 responds by sending a web API response containing a module corresponding to a file-bundling worker agent. In another example and as described further below in connection with FIG. 2B, the front-end application 272 generates web API calls for purposes of invoking build functions of the file-bundling worker agent. Moreover, in another example and as described further below in connection with FIG. 2B, the file-bundling agent generates web API calls for purposes of invoking status functions of the front-end application 272.

The front-end application 272, in general, provides, to the browser application 224, GUI selection content data 214 that represents output to be displayed (by the GUI 240) to a user of the client device 210. The user provides input 204 to the front-end application 272 by interacting with the GUI 240. As depicted in FIG. 2A, the input 204 may include one or multiple credentials 206, which, as an example, allow the server 271 to authenticate the user and establish that the user is affiliated with a customer account.

The input 204 also includes selected features for a particular file bundle. For example, as depicted in FIG. 2A, the input 204 includes one or multiple filter options 208. A filter option 208 refers to a criterion or criteria that identify one or multiple files for inclusion in a file bundle. The following are examples of filter options 208 for a file bundle that corresponds to a custom service pack. In an example, a filter option 208 may correspond to the selection of a particular platform model or a particular group of platform models by the user. In another example, a filter option 208 may correspond to the selection of a particular operating system or group of operating systems by the user. In another example, a filter option 208 may correspond to the selection of an operating system version.

In another example, a filter option 208 may correspond to the selection of a particular firmware package. In another example, a filter option 208 may correspond to the selection of a particular firmware package version. In another example, a filter option 208 may correspond to the selection of a particular utility or class of utilities. In another example, a filter option 209 may correspond to the selection of a particular firmware package for a particular peripheral. In another example, a filter option 208 may correspond to a particular update manager or a particular update manager version. Regardless of the type and/or number of filter options 208 provided by the user, the filter options 208 collectively identify the constituent files that the user has selected for inclusion into a file bundle. As can be appreciated, when related to a custom service pack, the files may correspond to a variety of computer platform models, operating systems, firmware packages, and other firmware and/or software.

The input 204 further includes data representing a file type 211 (or "bundle file type") for a file bundle. In an example, the file type 211 may be a TAR file. In another example, the file type 211 may be a ZIP file. In another example, the file type 211 may be an ISO image file.

When the user finishes selecting the features of a file bundle, the user may then initiate a bundle build request 212 to initiate the building of the file bundle. In an example, the GUI 240 may display a particular virtual input control (e.g., a clickable virtual build button), and the user may create the bundle request 212 by interacting with the virtual input control (e.g., by clicking on a virtual build button).

The sending of a bundle build request 212 causes the front-end application 272 to deploy a file-bundling worker agent to the client device 210. More specifically, referring to FIG. 2B, in response to a file bundle build request, the front-end application 272 deploys, to the browser application 224, a module corresponding to a file-bundling worker agent 230. In an example, the browser application 224 executes the file-bundling worker agent 230 to start, or launch, a file-bundling worker agent 230. As can be appreciated, the file-bundling worker agent 230 is hosted by the client device 210. The file-bundling worker agent 130 of FIG. 1 is an example of the file-bundling worker agent 230.

When launched, the file-bundling worker agent 230 exports file bundling build functions 236 (called "build functions" herein) of the worker agent 230 to the front-end application 272. For this purpose, the file-bundling worker agent 230 may submit a web API call to the front-end application 272. Exporting a build function 236 to the front-end application 272 means that the build function 236 is exposed to the front-end application 272 so that the front-end application 272 may invoke, or call, the build function 236. More specifically, the build functions 236 correspond to action handlers for corresponding build APIs that may be called by the front-end application 272 for purposes of using the file-bundling worker agent 230 (and therefore, the client device 210) to build a file bundle 280.

In an example, a build function 236 corresponds to an operation by the file-bundling worker agent 230 to retrieve a file from a file store 270 (e.g., a file store 268 of FIG. 1), and the front-end application 272 generates a build API call 234 to invoke this build function 236. The build API call 234 may, for example, include data that represents a URL and file access credential for the file. The file-bundling worker agent 230 responds to the build API call 234 by acknowledging the call 234 and retrieving the file from the file store 270.

In another example, a build function 236 corresponds to an operation by the file-bundling worker agent 230 to, after all of the constituent files for the file bundle 280 have been retrieved, assemble, or package, the constituent files into a single file having the selected bundle file type and corresponding to the file bundle 280. The front-end application 272 generates a build API call 234 to invoke this build function 236. The build API call 234 may, for example, include data that represents a file type for the file bundle 280. The file-bundling worker agent 230 responds to the build API call 234 by acknowledging the build API call 234 and assembling the constituent files into the single file corresponding to the file bundle 280.

In accordance with example implementations, the front-end application 272 exports status functions 250 of the front-end application 272 to the file-bundling worker agent 230. For this purpose, the front-end application 272 may submit a web API call to the file-bundling worker agent 230. By exporting a status function 250, the status function 250 is exposed to the file-bundling worker agent 230, which means the status function 250 may be called by the file-bundling worker agent 230. In accordance with example implementations, the status functions 250 correspond to action handlers for corresponding status APIs that may be called by the file-bundling worker agent 230 for purposes of causing the front-end application 272 to update the GUI 240 with build status information.

In an example, a status function 250 corresponds to displaying, on the GUI 240, a notification that a file bundle 280 is available. For example, when a file bundle build is complete, the file-bundling worker agent 230 generates a status API call 248 to the front-end application 272 to invoke the status function 250. The front-end application 272 responds by generating GUI status data 252 to display, on the GUI 240, a notification that the file bundle 280 is available. For implementations in which the file worker agent 230 may build multiple file bundles 280, the status API call 248 may specifically identify the file bundle 280.

In another example, a status function 250 corresponds to displaying, on the GUI 240, a file-bundling build progress. In an example, at different intervals of a file bundle build, the file-bundling worker agent 230 generates a status API call 248 to invoke the status function 250. In an example, the status API call 248 may include data identifying the file bundle 280, and the status API call 248 may include data representing the file-bundling progress (e.g., a percentage of remaining time, a percentage of files retrieved, an indication of a particular phase of the build, or other indication of progress). The front-end application 272 responds by generating GUI status data 252 to display, on the GUI 240, the file-bundling build progress.

In another example, a status function 250 corresponds to displaying, on the GUI 240, information about a particular retrieved file (e.g., a file name, a file size, a creation date, or other information). For example, the file-bundling worker agent 230 generates a status API call 248 to invoke the status function 250 after each file is retrieved from a file store 270. In an example, the status API call 248 may include data representing information about the file. The front-end application 272 responds by generating GUI status data 252, to display, on the GUI 240, the information about the file.

In another example, a status function 250 corresponds to displaying, on the GUI 240, information about the file bundle 280 (e.g., a name, a size, a creation date, or other information). For example, the file-bundling worker agent 230 generates a status API call 248 to invoke the status function 250 when the file bundle 280 is available. In an example, the status API call 248 may include data representing information about the file bundle 280. The front-end application 272 responds by generating GUI status data 252, to display, on the GUI 240, the information about the file bundle 280.

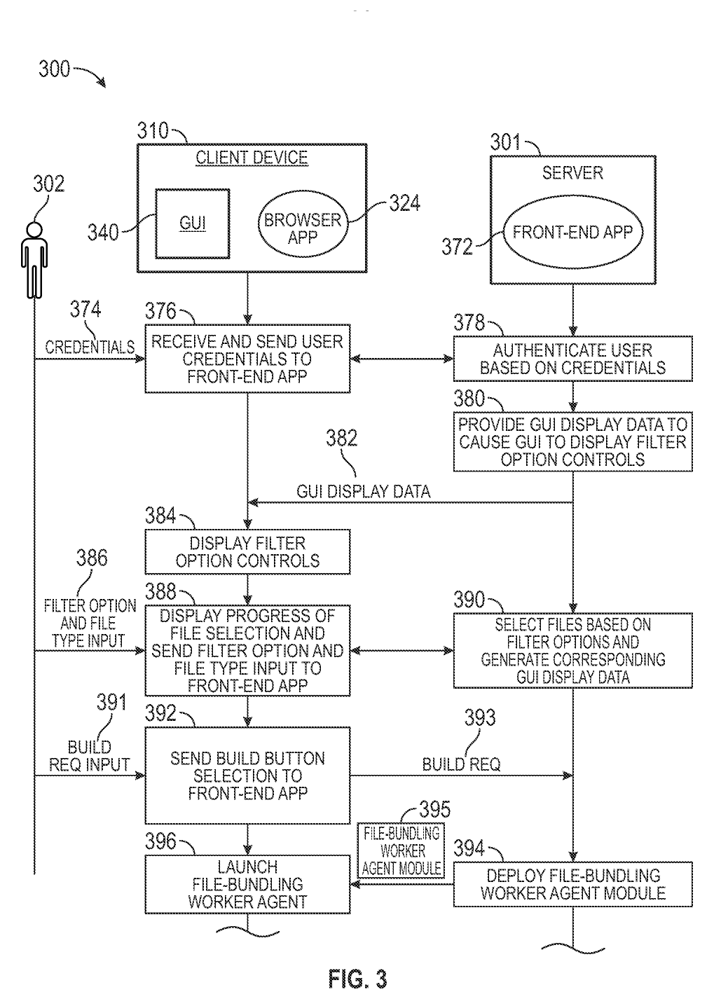

FIG. 3 is a sequence flow diagram 300 depicting actions taken by a client device 310 and a server 301 for purposes of setting up a file-bundling architecture, in accordance with example implementations. The client devices 110 (FIG. 1) and 210 (FIGS. 2A and 2B) are examples of the client device 310. The server 171 (FIG. 1) and 271 (FIGS. 2A and 2B) are examples of the server 301. The client device 310 hosts a browser application 324 that provides a GUI 340. The GUIs 140 (FIG. 1) and 240 (FIGS. 2A and 2B) are examples of the GUI 340. The browser application 124 of FIG. 1 is an example of the browser application 324. The server 371 hosts a front-end application 372. The front-end application 172 (FIG. 1) and the front-end application 272 (FIGS. 2A and 2B) are examples of the front-end application 372.

Referring to FIG. 3, through the GUI 340, the user 302 provides input to the front-end application 372 and receives output provided by the front-end application 372. The flow sequence 300 includes the user 302 providing, to the client device 310, user credentials 374. As depicted at 376, the client device 310 receives and sends the user credentials 374 to the server the front-end application 372. As depicted at 378, the front-end application 372 authenticates the user 302 based on the provided credentials 374. It is assumed in the following discussion that the authentication is successful.

Next, the front-end application 372, as depicted at 380, provides GUI display data 382 to cause the GUI 340 to display filter option controls. As depicted at 384, the browser application 324, in response to the GUI display data 382, displays the filter option controls.

The user 302 may then provide filter option and bundle file type input 386 via the GUI 340. As depicted at 388, the GUI 340 displays progress of the file selection and sends the file selection and file input to the front-end application 372. The front-end application 372, as depicted at 390, selects constituent files for the file bundle based on the filter options and generates corresponding GUI display data to display, on the GUI 340, information (e.g., file names, sizes and creation dates) about the selected files. In another example, the GUI 340 displays the selected filter options without displaying specific information about the files. In another example, the GUI 340 displays information summarizing the files associated with each selected filter option.

The user 302 may then, as depicted at 391, submit a build request to initiate operations to build the file bundle. In an example, the user 302 may select a virtual build button that is displayed on the GUI 340. In an example the user 302 may virtually depress the virtual build button using a mouse. As depicted at 392, the browser application 324 notifies the front-end application 372 about the selection of the build button, corresponding to a build request 393 being sent to the front-end application 372.

As depicted at 394, the front-end application 372, in response to the build request, deploys a file-bundling worker agent module 395 to the browser application 324. The browser application 324 receives the file-bundling worker agent module 395 and executes the module 395 to launch, or start, a file-bundling worker agent, as depicted at 396.

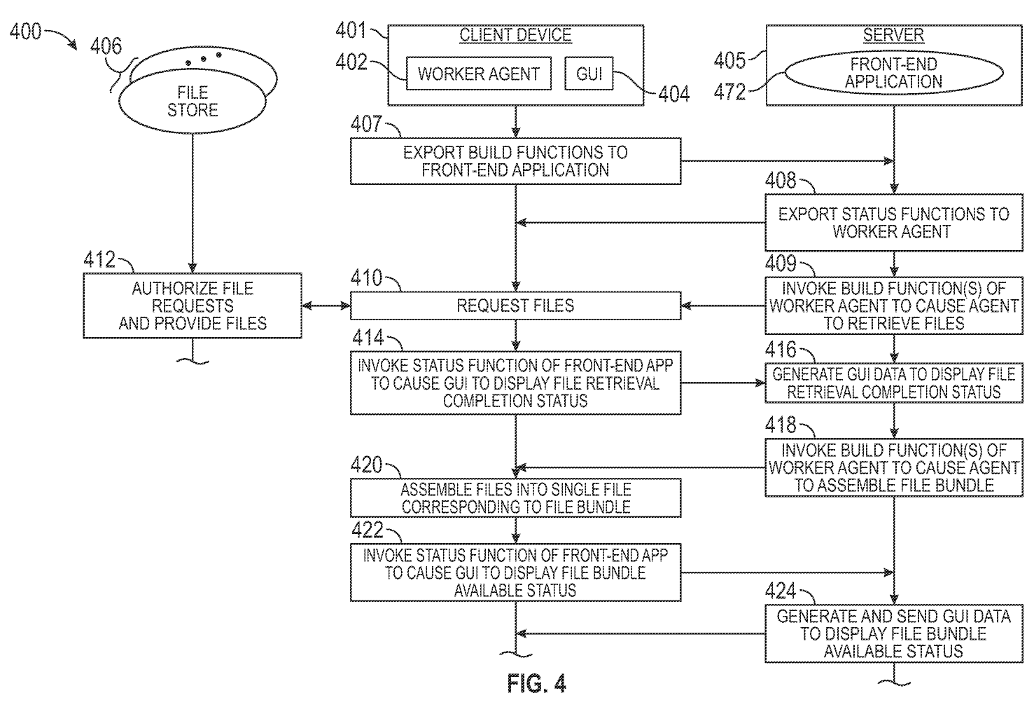

FIG. 4 is a sequence flow diagram 400 depicting actions taken by a client device 401 and a server 405 to build a file bundle using a file-bundling worker agent 402 that is hosted by the client device 401, in accordance with example implementations. The client device 110 (FIG. 1), the client device 210 (FIGS. 2A and 2B) and the client device 310 (FIG. 3) are examples of the client device 401. The server 171 (FIG. 1), the server 271 (FIGS. 2A and 2B) and the server 371 (FIG. 3) are examples of the server 405. The client device 401 hosts the file-bundling worker agent 402 and also hosts a GUI 404, and the server 471 hosts a front-end application 472. In an example, the file-bundling worker agent 402 may be executed by a browser application of the client device 410. The file-bundling worker agent 130 (FIG. 1), the file-bundling worker agent 230 (FIG. 2B) and the file-bundling worker agent 330 (FIG. 3) are examples of the file-bundling worker agent 402. The GUI 140 (FIG. 1), GUI 240 (FIGS. 2A and 2B) and GUI 340 (FIG. 3) are examples of the GUI 404. The server 405 host a front-end application 472. The front-end application 172 (FIG. 1), the front-end application 272 (FIGS. 2A and 2B) and the front-end application 372 (FIG. 3) are examples of the front-end application 472.

The sequence 400 begins, as depicted at 407, with the file-bundling worker agent 402 exporting its build functions to the front-end application 472. Moreover, as depicted at 408, the front-end application 472 exports its status functions to the file-bundling worker agent 402.

Next, as depicted at 409, the front-end application 472 invokes one or multiple build functions of the file-bundling worker agent 402 to cause the worker agent 402 to retrieve constituent files for the file bundle. In an example, the front-end application 472 calls one or multiple APIs to invoke the build function. In an example, through the API calls, the front-end application 472 provides, to the file-bundling worker agent 402, information (e.g., URLs) identifying the locations of the files. In an example, through the API calls, the front-end application 472 provides, to the file-bundling worker agent 402, file access credentials to allow the file-bundling worker agent 402 to access and retrieve the files from one or multiple file store(s) 406. In an example, the file access credentials may be time-limited, and the file access credentials and URLs may be provided to the front-end application 472 by a credential manager.

Responsive to the invoked functions, the file-bundling worker agent 402 requests the files from one or multiple file stores 406. For this purpose, the file-bundling worker agent 402 may access the files by providing the URLs and file access credentials to the file store(s) 406. As depicted at 412, the file store(s) 406 authorize the file requests and provide the requested files.

Next, the file-bundling worker agent 402, as depicted at 414, invokes a status function of the front-end application 472 to cause the GUI 404 to display a file retrieval completion status. Responsive to the invoked function, the front-end application 472, as depicted at 416, generates GUI data to display the file retrieval completion status.

The front-end application 472 then, pursuant to the sequence 400 and as depicted at 418, invokes one or multiple build functions to the file-bundling worker agent 402 to cause the worker agent 402 to assemble the file bundle, as depicted at 420. In an example, the file-bundling worker agent 402 packages the constituent files into a single file that corresponds to the bundle file type selected by the user. The file-bundling worker agent 402 next, as depicted at 422, invokes a status function of the front-end application 472 to cause the GUI 404 to display a notification that the file build is available. Responsive to the status function being invoked, the front-end application sends GUI data to the browser application to display the notification, as depicted at 424.

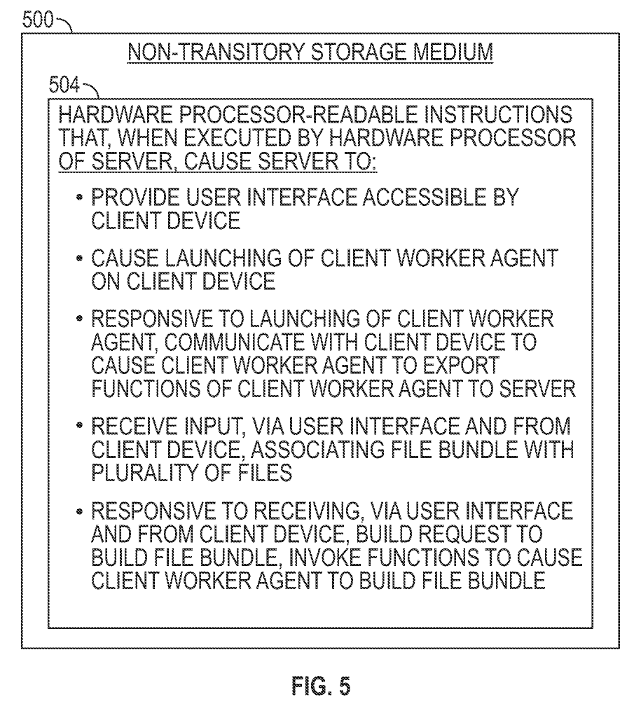

Referring to FIG. 5, in accordance with example implementations, a non-transitory storage medium 500 stores hardware processor-readable instructions 504 that, when executed by a hardware processor of a server, cause the server to provide a user interface, which is accessible by a client device. In an example, the server corresponds to a virtual machine. In another example, the server corresponds to a physical server. In examples, the physical server may be a blade server, a rack server or a tower server. In another example, the server may be a distributed server. In an example, the server may be a software-defined server. In an example, the server may provide a file bundling service. In an example, the server may be affiliated with an OEM and provide a custom service pack build service. In an example, the custom service pack build service allows a customer of the OEM to create a custom service pack that includes a lesser subset of files contained in a particular service pack release. In examples, the client device may be a laptop computer, a table computer, a desktop computer, smartphone or other computer platform.

The instructions 504, when executed by the hardware processor, further cause the server to cause launching of a client worker agent on the client device. In an example, the server sends a program code to a browser application of the client device, and the browser application executes the module for purposes of launching the client worker agent. In an example, the module is a WebAssembly module. In an example, the client worker agent may be a file-bundling worker agent that is constructed to perform file-bundling build operations on the client device. In an example, the build operations include operations to retrieve files of a file bundle and package the retrieved files into a single file corresponding to the file bundle.

The instructions 504, when executed by the hardware processor, further cause the hardware processor to, responsive to the launching of the client worker agent, communicate with the client device to cause the client worker agent to export functions of the client worker agent to the server. In an example, the exported functions are file bundling build operations of the client worker agent. In an example, exporting the functions allows a front-end application of the server to call the build functions using API calls.

The instructions 504, when executed by the hardware processor, further cause the hardware processor to receive input, via the user interface and from the client device, associating a file bundle with a plurality of files. In an example, the plurality of files corresponds to a service pack release. In an example, the plurality of files corresponds to software and firmware for a particular collection of computer platforms. In an example, the input may correspond to the selection of filter options. In examples, the filter options may select one or multiple of operating systems, computer platform models, operating system versions, firmware package versions, firmware packages, or peripheral firmware.

The instructions 504, when executed by the hardware processor, further cause the server to, responsive to receiving, via the user interface and from the client device, a build request to build the file bundle, invoke functions to cause the client device to build the file bundle. In an example, a user may submit the build request by selecting a graphical control provided by a GUI that corresponds to a portal. In an example, the GUI may display a build button that is selectable by the user to initiate the file bundle build. In an example, responsive to the build request, a front-end application of the server invokes the functions of the client device. In an example, the functions of the client device correspond to functions of a file-bundling worker agent that is deployed, by the front-end application, to the client device.

In an example, the front-end application includes status functions that the front-end application exports to the client worker agent. In an example, a status function corresponds to an operation by the front-end application to update a GUI of the client device with a status of a particular file bundle build. In another example, a status function corresponds to an operation by the front-end application to display, on a GUI of the client device, a notification that a file bundle is available. In an example, the exporting of the status functions allow the client worker agent to call the status functions, as the client worker agent is building a file bundle.

In an example, the front-end application may be a monolithic application. In an example, the front-end application may be a microservice-based application. In an example, a file bundle may be an ISO image file. In another example, a file bundle may be a TAR file. In another example, a file bundle may be a ZIP file. In an example, the user may provide input to the server, such as input to a front-end application of the server, for purposes of selecting a particular file type for the bundle.

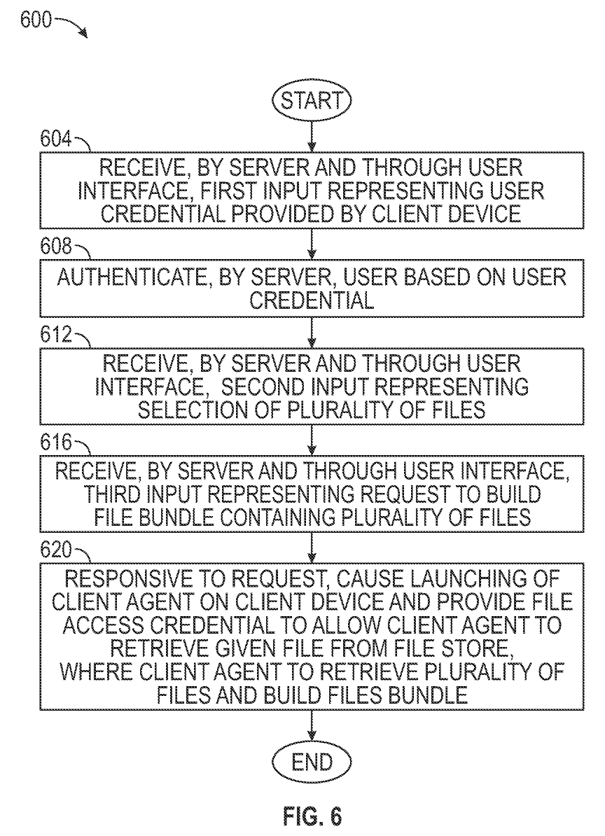

Referring to FIG. 6, in accordance with example implementations, a technique 600 includes receiving (block 604), by a server and via a user interface, first input representing a user credential that is provided by a client device. In an example, the user interface may be a GUI that corresponds to a portal and is provided by a browser application. In an example, the server executes a front-end application to perform the technique.

In an example, the server corresponds to a virtual machine. In another example, the server corresponds to a physical server. In examples, the physical server may be a blade server, a rack server or a tower server. In another example, the server may be a distributed server. In an example, the server may be a software-defined server. In an example, the server may provide a file bundling service. In an example, the server may be affiliated with an OEM and provide a custom service pack build service. In an example, the custom service pack build service allows a customer of the OEM to create a custom service pack that includes a lesser subset of files contained in a particular service pack release.

In an example, the client device is an edge device. In examples, the client device may be a laptop computer, a table computer, a desktop computer, a smartphone, or other computer platform.

Pursuant to block 608, the technique 600 includes authenticating, by the server, a user based on the user credential. In an example, the server serves a portal, and through the portal, the server prompts the user for login credentials. The technique 600 includes, pursuant to block 612, receiving, by the server and through the user interface, a second input that represents a selection of a plurality of files. In an example, the plurality of files corresponds to a service pack release. In an example, the plurality of files corresponds to software and firmware for a particular collection of computer platforms. In an example, the input may correspond to the selection of filter options. In examples, the filter options may select one or multiple of operating systems, computer platform models, operating system versions, firmware package versions, firmware packages, or peripheral firmware.

Pursuant to block 616, the technique 600 includes receiving, by the server and through the user interface, a third input representing a request to build a file bundle containing the plurality of files. In examples, the file bundle is packaged as an ISO image file, a TAR file or a ZIP file. In an example, the file bundle corresponds to a custom service pack, and the plurality of files correspond to a lesser subset of files of a service pack release. In an example, a user submits the request by manipulating an input mechanism provided by a GUI of the client device. In an example, the GUI displays a build button that is selectable by the user to initiate the file bundle build.

The technique 600 includes, responsive to the request, causing (block 620) launching of a client agent on the client device and providing a file access credential to allow the client agent to retrieve a given system file from a file store. The client agent retrieves the plurality of files and builds the file bundle. In an example, the server provides a code module to the client device in response to the request. In an example, the server sends the code module to a browser application of the client device. In an example, the browser application executes the code module to launch the client agent. In an example, the code module is a WebAssembly module.

In an example, the client agent has build functions, and the client agent exports the build functions to the server. In an example, the server calls the build functions to cause the client agent retrieve files of the plurality of files from one or multiple file stores. In an example, the server calls the build functions to cause the client agent to package the files as a single file corresponding to the file bundle.

In an example, the server hosts a front-end application, and the front-end application has status functions to display statuses related to a file bundle build on a GUI of the client device. In an example, the front-end application exports the status functions to the client agent. In an example, the client agent calls the status functions as the client agent is building a file bundle to cause the front-end application display build statuses on the GUI. In an example, the server may be hosted by resources corresponding to a public cloud. In another example, the server may be hosted by resources corresponding to a private cloud. In another example, the server may be hosted by resources corresponding to a hybrid cloud. In another example, the server may be hosted by non-cloud resources.

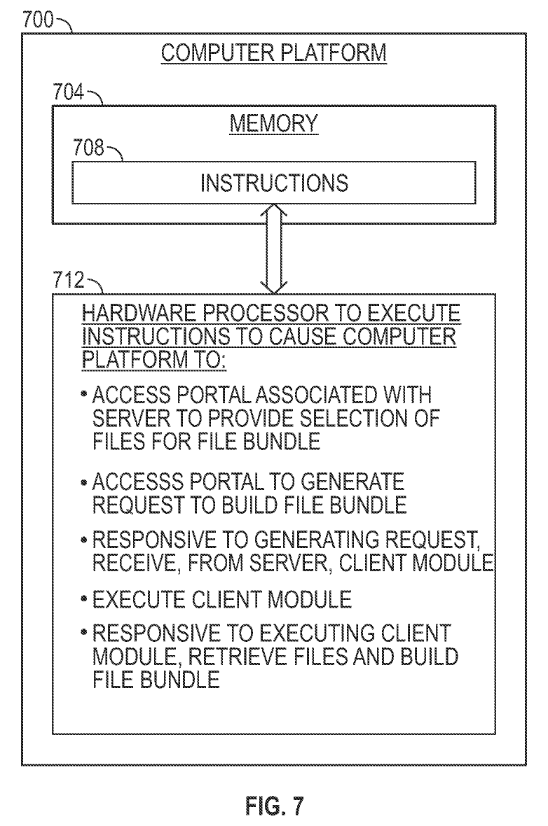

Referring to FIG. 7, in accordance with example implementations, a computer platform 700 includes a memory 704 and a hardware processor 712. The memory 704 stores instructions 708. The instructions 708, when executed by the hardware processor 712, cause the computer platform 700 to access a portal. In an example, the computer platform 700 is a client device. In another example, the computer platform 700 is an edge device. In other examples, the computer platform is a laptop computer, a table computer, a desktop computer or a smartphone. In an example, the portal is associated with an OEM and further associated with a custom service pack build service. In an example, the custom service pack build service allows a customer of the OEM to create a custom service pack that includes a lesser subset of files contained in a particular service pack release. In an example, the service pack release is an ISO image file, and the custom service pack is an ISO image file, a TAR file or a ZIP file.

The instructions 708, when executed by the hardware processor 712, further cause the computer platform 700 to access the portal to generate a request to build the file bundle; and responsive to generating the request, receive, from the server, a client module. In an example, the request corresponds to a web API call. In an example, the client module corresponds to executable program code. In an example, the client module comprises a WebAssembly module. In an example, a browser application hosted by the client receives and executes the client module. In an example, the browser application provides a GUI corresponding to the portal. In an example, the browser application provides, to the server, a web API call corresponding to the request to build the file bundle.

The instructions 708, when executed by the hardware processor 712, further cause the hardware processor 712 to execute the client module; and responsive to executing the client module, retrieve the files and build the file bundle. In an example, executing the client module launches a file-bundling worker agent on the computer platform 700. In an example, the file-bundling worker agent, retrieves the files and packages the retrieved files into a single file that corresponds to the file bundle. In an example, the single file is an ISO image file, a TAR file or a ZIP file. In an example, the file-bundling worker agent has build functions, and the file-bundling worker agent exports the build functions to the server. In an example, the server calls the build functions to cause the file-bundling worker agent to retrieve files of the plurality of files from one or multiple file stores. In an example, the server calls the build functions to cause the file-bundling worker agent to package the files as a single file corresponding to the file bundle. In an example, the server hosts a front-end application, and the front-end application has status functions to display statuses related to a file bundle build on a GUI of the client device. In an example, the front-end application exports the status functions to the file-bundling worker agent. In an example, the file-bundling worker agent calls the status functions as the file-bundling worker agent is building a file bundle to cause the front-end application to display build statuses on the GUI.

In accordance with example implementations, the input includes a filter option that identifies a computer platform model. The instructions, when executed by the hardware processor, further cause the hardware processor to identify files of the plurality of files based on the computer platform model. Among the potential advantages, because the client device builds the file bundle, there is no server side-imposed wait time for the build.

In accordance with example implementations, the input includes a filter option that identifies an operating system name. The instructions, when executed by the hardware processor, further cause the hardware processor to identify files of the plurality of files based on the operating system name. Among the potential advantages, because the client device builds the file bundle, there is no server side-imposed wait time for the build.

In accordance with example implementations, the input includes a filter option identifying a firmware package version. The instructions, when executed by the hardware processor, further cause the hardware processor to identify a file of the plurality of files based on the firmware package version. Among the potential advantages, because the client device builds the file bundle, there is no server side-imposed wait time for the build.

In accordance with example implementations, the client device includes a browser. The instructions, when executed by the hardware processor, further cause the server to provide, to the client device, program code corresponding to the client worker agent. Among the potential advantages, because the client device builds the file bundle, there is no server side-imposed wait time for the build.

In accordance with example implementations, the instructions, when executed by the hardware processor, further cause the server to invoke a given function to cause the client worker agent to download a given file of the plurality of files from a file store. Among the potential advantages, because the client device builds the file bundle, there is no server side-imposed wait time for the build.

In accordance with example implementations, the instructions, when executed by the hardware processor, further cause the server to provide to the client device, a credential to allow the client worker agent to download a file of the plurality of files. Among the potential advantages, because the client device builds the file bundle, there is no server side-imposed wait time for the build.

In accordance with example implementations, the input further specifies a file format for the file bundle. The instructions, when executed by the hardware processor, further cause the server to invoke the functions to cause the client worker agent to retrieve the plurality of files from at least one file store, and further cause the client to create a file that corresponds to the file bundle and includes content corresponding to the plurality of files. Among the potential advantages, because the client device builds the file bundle, there is no server side-imposed wait time for the build.

In accordance with example implementations, the file corresponds to a disk image. Among the potential advantages, because the client device builds the file bundle, there is no server side-imposed wait time for the build.

In accordance with example implementations, the file has a compressed file content. Among the potential advantages, because the client device builds the file bundle, there is no server side-imposed wait time for the build.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms "a," "an," and "the" are intended to include the plural forms as well, unless the context clearly indicates otherwise. The term "plurality," as used herein, is defined as two or more than two. The term "another," as used herein, is defined as at least a second or more. The term "connected," as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term "and/or" as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term "includes" means includes but not limited to, the term "including" means including but not limited to. The term "based on" means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A non-transitory storage medium that stores hardware processor-readable instructions that, when executed by a hardware processor of a server, cause the server to:
provide a user interface accessible by a client device;
cause launching of a client worker agent on the client device;
responsive to the launching of the client worker agent, communicate with the client device to cause the client worker agent to export functions of the client worker agent to the server;
receive an input, via the user interface and from the client device, associating a file bundle with a plurality of files; and
responsive to receiving, via the user interface and from the client device, a build request to build the file bundle, invoke the functions to cause the client worker agent to build the file bundle.

2. The storage medium of claim 1, wherein:
the input comprises a filter option identifying a computer platform model; and
the instructions, when executed by the hardware processor, further cause the hardware processor to identify files of the plurality of files based on the computer platform model.

3. The storage medium of claim 1, wherein:
the input comprises a filter option identifying an operating system name; and
the instructions, when executed by the hardware processor, further cause the hardware processor to identify files of the plurality of files based on the operating system name.

4. The storage medium of claim 1, wherein:
the input comprises a filter option identifying a firmware package version; and
the instructions, when executed by the hardware processor, further cause the hardware processor to identify a file of the plurality of files based on the firmware package version.

5. The storage medium of claim 1, wherein:
the client device comprises a browser;
the instructions, when executed by the hardware processor, further cause the server to provide, to the client device, program code corresponding to the client worker agent.

6. The storage medium of claim 1, wherein the instructions, when executed by the hardware processor, further cause the server to invoke a given function of the functions to cause the client worker agent to download a given file of the plurality of files from a file store.

7. The storage medium of claim 1, wherein the instructions, when executed by the hardware processor, further cause the server to provide, to the client device, a credential to allow the client worker agent to download a file of the plurality of files.

8. The storage medium of claim 1, wherein:
the input further specifies a file format for the file bundle; and
the instructions, when executed by the hardware processor, further cause the server to invoke the functions to cause the client worker agent to retrieve the plurality of files from a file store, and further cause the client to create a file that corresponds to the file bundle and includes content corresponding to the plurality of files.

9. The storage medium of claim 8, wherein the file corresponds to a disk image.

10. The storage medium of claim 8, wherein the file has a compressed file content.

11. A method comprising:
receiving, by a server and via a user interface, first input representing a user credential provided by a client device;
authenticating, by the server, a user based on the user credential;
receiving, by the server and through the user interface, second input representing a selection of a plurality of files;
receiving, by the server and through the user interface, third input representing a request to build a file bundle containing the plurality of files; and
responsive to the request, causing, by the server, launching of a client worker agent on the client device and providing, by the server, a file access credential to allow the client worker agent to retrieve a given file of the plurality of files from a file store, wherein the client worker agent to retrieve the plurality of files and build the file bundle.

12. The method of claim 11, wherein causing launching of the client worker agent comprises responsive to the request, sending, by the server and to the client device, program code corresponding to the client worker agent.

13. The method of claim 11, further comprising invoking, by the server, a function of the client worker agent, to cause the client worker agent to retrieve the given file from the file store.

14. The method of claim 13, wherein the invoking further comprises providing, by the server and to the client worker agent, data representing the file access credential and an identifier for the given file.

15. The method of claim 11, further comprising invoking, by the server, a function of the client worker agent, to cause the client worker agent to build the file bundle.

16. The method of claim 15, wherein the invoking further comprises providing, by the server and to the client worker agent, data representing a file type for the file bundle.

17. The method of claim 11, further comprising responding, by the server, to an invocation, by the client worker agent, of a function associated with the interface, wherein the invocation is associated with the client worker agent provided a status of the build, and wherein responding to the invocation comprises generating, by the server, data to display, on the interface, the status.

18. A computer platform comprising:
a hardware processor; and
a memory that stores instructions to, when executed by the hardware processor, cause the computer platform to:
access a portal associated with a server to provide a selection of files for a file bundle;
access the portal to generate a request to build the file bundle;
responsive to generating the request, receive, from the server, a client module;
execute the client module;
responsive to executing the client module, retrieve the files and build the file bundle.

19. The computer platform of claim 18, wherein the instructions to, when executed by the hardware processor, further cause the computer platform to:
retrieve the files and build the file bundle responsive to the server invoking functions of the client module.

20. The computer platform of claim 18, wherein the instructions to, when executed by the hardware processor, further cause the computer platform to:
responsive to the execution of the client module, invoke a function of the server to cause the server to display a status associating with building the file bundle.
